(19) United States
(12) Patent Application Publication
(10) Pub. No.: US 2026/0368778 A1
(43) Pub. Date: Nov. 19, 2026

(54) IDENTIFYING AND PREDICTING TRENDING APPLICATIONS

(71) Applicant: Google LLC, Mountain View, CA (US)

(72) Inventors: Zilu Zhou, Mountain View, CA (US); Dinglong Li, Mountain View, CA (US); Bruce Ban Herm Chia, Mountain View, CA (US)

(21) Appl. No.: 19/145,779

(22) PCT Filed: Jan. 11, 2024
(86) PCT No.: PCT/US2024/011290

§ 371 Date: Jul. 3, 2025

Related U.S. Application Data
(60) Provisional application No. 63/479,634, filed on Jan. 12, 2023.

(51) Int. Cl. G06Q 30/0251; G06N 20/00

(52) U.S. Cl. CPC G06Q 30/0254; G06N 20/00

(57) ABSTRACT

A computing system determines, for each time period from a plurality of time periods, a trending metric for an application available through an application marketplace. The computing system determines whether the trending metric for a final period of the plurality of time periods is greater than the trending metric for an initial period of the plurality of time periods by an amount satisfying a first significance level. The computing system classifies the application as trending in response to determining that the trending metric for the final period is greater than the trending metric for the initial period by the amount satisfying the first significance level. The computing system displays the application as trending in the application marketplace m response to classifying the application as trending.

This application claims the benefit of U.S. Provisional Application Ser. No. 63/479,634, filed Jan. 12, 2023, the entire content of which is incorporated herein by reference.

### BACKGROUND

Computing devices, such as mobile computing devices, may run a variety of software applications that extend existing device capabilities and add new capabilities. Many types of applications are generally available, such as applications for information retrieval, communications and entertainment. Applications may be created by mobile device manufacturers and/or third parties (e.g., application developers), may be pre-installed by the manufacturer, and/or may be downloaded and installed by device users.

### SUMMARY

Techniques are described by which a computing system may identify and predict whether an application available in an application marketplace (e.g., application store) is trending. In accordance with techniques of this disclosure, a computing system may determine a trending metric for an application for each time period from a plurality of time periods. The computing system may determine whether the trending metric for the application increased in the long-term (and optionally the short-term) by a statistically significant amount. Responsive to determining that the trending metric has increased by a statistically significant amount, the computing system may classify the application as trending and display the application as trending in the application marketplace (e.g., under the “Trending Application” category, under the “For You” application category, on the homepage of the application marketplace, under various subcategories of applications like games, kids, news, etc.). Additionally, the computing system may train and apply a machine learning model to predict whether an application will be classified as trending. The computing system may preemptively display the application as trending in the application marketplace based on the predictions by the machine learning model. In this way, the computing system may promote the visibility and adoption of an application to users who are interested in trending applications but who likely are not yet aware of the application.

In some examples, a method includes determining, by a computing system and for each time period from a plurality of time periods, a trending metric for an application available through an application marketplace; determining, by the computing system, whether the trending metric for a final period of the plurality of time periods is greater than the trending metric for an initial period of the plurality of time periods by an amount satisfying a first significance level; classifying, by the computing system, the application as trending in response to determining that the trending metric for the final period is greater than the trending metric for the initial period by the amount satisfying the first significance level; and displaying, by the computing system, the application as trending in the application marketplace in response to classifying the application as trending.

In some examples, a computing system includes one or more processors; a memory that stores instructions that, when executed by the one or more processors, cause the one or more processors to: determine, for each time period from a plurality of time periods, a trending metric for an application available through an application marketplace; determine whether the trending metric for a final period of the plurality of time periods is greater than the trending metric for an initial period of the plurality of time periods by an amount satisfying a first significance level; classify the application as trending in response to determining that the trending metric for the final period is greater than the trending metric for the initial period by the amount satisfying the first significance level; and display the application as trending in the application marketplace in response to classifying the application as trending.

In some examples, a non-transitory computer-readable storage medium stores instructions that, when executed, cause one or more processors of a computing system to determine, for each time period from a plurality of time periods, a trending metric for an application available through an application marketplace; determine whether the trending metric for a final period of the plurality of time periods is greater than the trending metric for an initial period of the plurality of time periods by an amount satisfying a first significance level; classify the application as trending in response to determining that the trending metric for the final period is greater than the trending metric for the initial period by the amount satisfying the first significance level; and display the application as trending in the application marketplace in response to classifying the application as trending.

In some examples, an apparatus includes means for determining, for each time period from a plurality of time periods, a trending metric for an application available through an application marketplace; means for determining whether the trending metric for a final period of the plurality of time periods is greater than the trending metric for an initial period of the plurality of time periods by an amount satisfying a first significance level; means for classifying the application as trending in response to determining that the trending metric for the final period is greater than the trending metric for the initial period by the amount satisfying the first significance level; and means for displaying the application as trending in the application marketplace in response to classifying the application as trending.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system for identifying and predicting trending applications, in accordance with one or more aspects of the present disclosure.

FIG. 2 is a block diagram illustrating details of a computing system for identifying and predicting trending applications, in accordance with one or more techniques of this disclosure.

FIG. 3 is a block diagram illustrating details of a computing device for identifying and predicting trending applications, in accordance with one or more techniques of this disclosure.

FIG. 4 is a flowchart illustrating example operations of an example computing system for identifying and predicting trending applications, in accordance with one or more techniques of the present disclosure.

FIG. 5 a flowchart illustrating example operations of an example computing system for identifying and predicting trending applications, in accordance with one or more techniques of the present disclosure.

### DETAILED DESCRIPTION

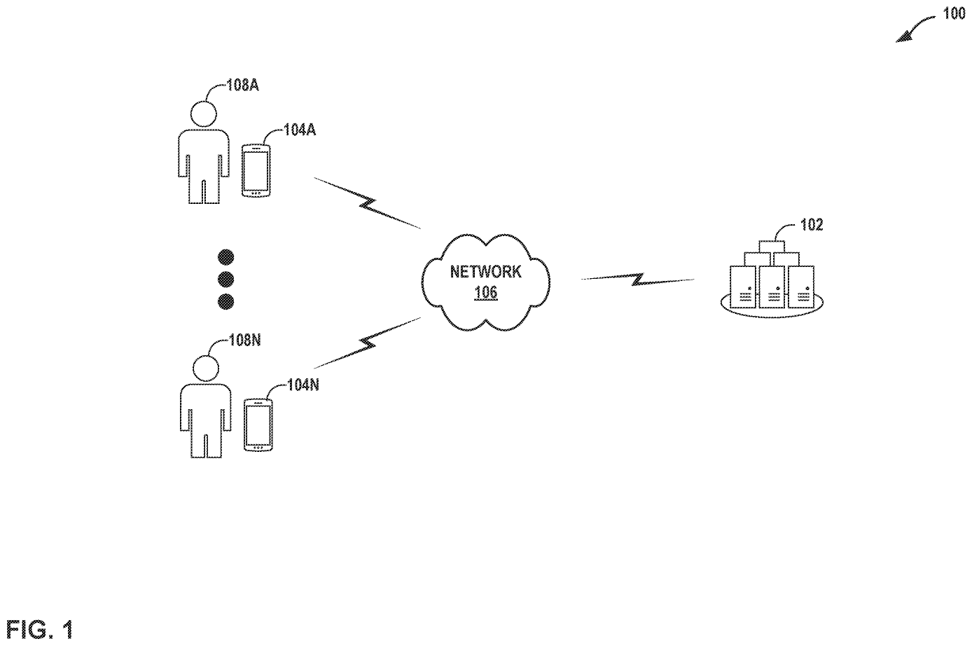

FIG. 1 is a conceptual diagram illustrating an example system 100. FIG. 1 illustrates only one particular example of system 100, and many other examples of system 100 may be used in other instances. In the example of FIG. 1, system 100 includes a computing system 102 and computing devices 104A-104N (collectively, “computing devices 104”) that may each communicate with computing system 102 over a network 106. Computing system 102 may include one or more computing devices and one or more machine-readable repositories (e.g., databases). Computing devices 104 may have associated users 108A-108N (collectively, “users 108”), respectively.

In the example of FIG. 1, each of computing devices 104 may be a mobile computing device, such as a smartphone. However, computing devices 104 may be any type of computing device, such as a camera device, a tablet computer, a laptop computer, a desktop computer, an e-book reader, or a wearable computing device (e.g., a computerized watch, computerized eyewear, etc.). Computing devices 104 may enable users 108 to interact with an application marketplace (e.g., an application store) hosted by computing system 102. In some examples, the application marketplace may be provided as an application that is executed on computing devices 104 and that retrieves application information from computing system 102.

The application marketplace may be hosted or otherwise provided by computing system 110. The application marketplace may enable users 108 of computing devices 104 to browse, search, select, purchase, download, and install various applications and application updates on computing devices 104. The application marketplace may advertise applications that are available for download to and installation on one or more of computing devices 104. For example, user 108A of computing device 104A may interact with the application marketplace to view applications of interest. For example, user 108A may input a search query to the application marketplace. Computing system 102 may process the search query to identify one or more applications corresponding to the search query, Computing system 102 may transmit information corresponding to the one or more applications to computing device 104A for display to user 108A.

In general, the application marketplace may display categories of applications (e.g., most recent applications, most downloaded applications, top free applications, top paid applications, featured applications, entertainment, productivity, business, education and the like). For example, in response to user 108A selecting a particular category, computing system 102 may transmit information corresponding to one or more applications within the particular category to computing device 104A for display to user 108A.

In some examples, the categories of applications may include trending applications (e.g., applications that are increasing in popularity among users 108). However, identifying a trending application (and subsequently displaying in the application marketplace under the “Trending Application” category) only after the application has reached mainstream popularity may not be useful to users 108 given the high likelihood that users 108 are already aware of the application by that point. At the same time, identifying a trending application before the application has reached mainstream popularity may be so difficult and infrequent that the “Trending Application” category does not provide much utility (e.g., novel and relevant information about applications for computing devices 104) to users 108.

In accordance with techniques of this disclosure, computing system 102 may determine a trending metric for an application available through the application marketplace. For example, computing system 102 may determine whether the trending metric for the application increased over a time period by an amount satisfying a significance level (e.g., a significance level, or a, of 0.05, 0.1, 0.15, etc.). In general, the significance level may represent or otherwise constitute a threshold. Responsive to determining that the trending metric has increased by a statistically significant amount during the time period, computing system 102 may classify the application as trending and display the application as trending in the application marketplace (e.g., under the “Trending Application” category).

Computing system 102 may determine a trending metric for an application available through the application marketplace for each time period from a plurality of time periods. The time period may be any length of time, such as any number of minutes, hours, days, etc. The plurality of time periods may consist of any number of time periods, such as 7, 14, and 21 time periods. The plurality of time periods may be a fixed time window or a sliding time window. As used herein, a fixed time window may refer to a time window where the initial and last (e.g., last) time periods of the time window remain the same, and a sliding time window may refer to a time window where the initial and last time periods of the time window change (e.g., increments by one period) with the passage of each time period.

In general, the trending metric for an application may measure an increase in popularity of the application among users 108. In some examples, the trending metric may include one or more of an engagement metric (e.g., an application engagement metric) or an active user metric (e.g., a daily active user metric). The engagement metric may measure application usage data, such as an amount of time a user spends interacting with the application. The active user metric may measure a number of users who have the application installed on a computing device and have used the application (e.g., during the plurality of time periods of the time window).

The engagement metric may represent or otherwise constitute a continuous variable. The active user metric may represent or otherwise constitute an integer variable. Thus, in examples where the trending metric includes the engagement metric and the active user metric, the trending metric may identify an application that is trending based on a multi-dimensional framework. It should be understood that other examples of the trending metric (as well as metrics included in the trending metric) are contemplated by this disclosure. The data for the plurality of time periods may be processed (e.g., smoothened, filtered, averaged, etc.) to reduce the influence of, for example, seasonality, on the trending metric (as well as the influence of seasonality on metrics included in the trending metric).

Computing system 102 may determine whether the trending metric for a final period of the plurality of time periods is greater than the trending metric for an initial period of the plurality of time periods by an amount satisfying a first significance level. Computing system 102 may classify the application as trending in response to determining that the trending metric for the final period is greater than the trending metric for the initial period by at least the amount satisfying the first significance level. In some examples, the first significance level may be 0.05. However, other values of the first significance level are contemplated by this disclosure, such as 0.1, 0.15, etc. The change in the trending metric from the initial period to the final period may represent a long-term trend in the trending metric.

In some examples, computing system 102 may determine whether the trending metric for the final period is greater than the trending metric for an intermediate period (e.g., any period that is between the initial period and the final period) of the plurality of time periods by an amount satisfying a second significance level. In some examples, the second significance level may be 0.1. However, other values of the second significance level are contemplated by this disclosure, such as 0.2, 0.3, etc. The change in the trending metric from the intermediate period to the final period may represent a short-term trend in the trending metric.

Computing system 102 may classify the application as trending in response to: determining that the trending metric for the final period is greater than the trending metric for the initial period by the amount satisfying the first significance level; and determining that the trending metric for the final period is greater than the trending metric for the intermediate period by the amount satisfying the second significance level. The first significance level may be less than the second significance level (e.g., because more data is available for the long-term trend in the trending metric than the short-term trend in the trending metric, allowing for greater confidence in a classification of trending), For example, the first significance level may be 0.05, and the second significance level may be 0.1.

It should be understood that computing system 102 may determine any number of trends (e.g., 3, 5, 10, etc.), including trends other than the short-term trend and long-term trend described above, and classify applications based on any combination of the determined trends. Additionally, it should be understood that computing system 102 may determine a trend based on a change between any two periods from the plurality of time periods, including between the initial period and an intermediate period, between a first intermediate period and a second intermediate period, etc. Each trend determined by computing system 102 may have an associated significance level, which, in some examples, may be based on the duration of the trend (e.g., the number of time periods included in the trend).

Responsive to classifying the application as trending, computing system 102 may display the application as trending in the application marketplace. Given the considerable effect displaying an application under the “Trending Application” category may have on the visibility and adoption of the application among users 108, it is important that the classification of the application is reliable (e.g., correct). Determining whether the trending metric for the final period is greater than the trending metric for the initial period by an amount satisfying the first significance level may ensure that the increase in the trending metric from the initial period to the final period is statistically significant (e.g., not due to randomness). Similarly, determining whether the trending metric for the final period is greater than the trending metric for the intermediate period by an amount satisfying the second significance level may ensure that the increase in the trending metric from the intermediate period to the final period is statistically significant. Thus, an advantage of the techniques of this disclosure may include demonstrating, via one or more widely used statistical techniques, that a classification of an application as trending is reliable. Additionally, by more accurately classifying an application as trending, it may be easier for users 108 to find the application, which may result in fewer interactions and less resources (e.g., power, processor cycles, memory space, memory bus bandwidth, wireless bandwidth) required.

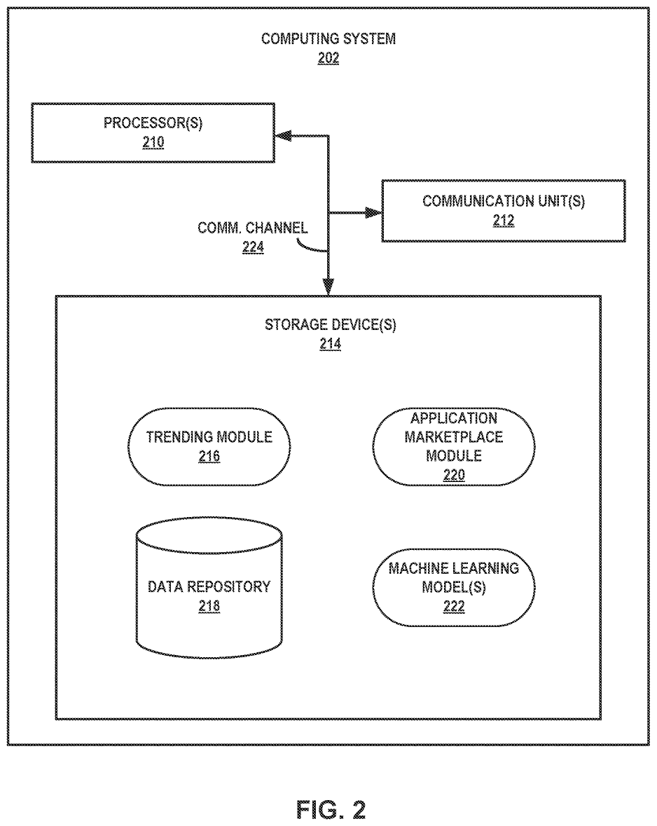

FIG. 2 is a block diagram illustrating details of a computing system 202 in accordance with one or more techniques of this disclosure. Computing system 202 of FIG. 2 may be an example of system 102 illustrated in FIG. 1. FIG. 2 illustrates only one particular example of computing system 202, and many other examples of computing system 202 may be used in other instances and may include a subset of the components included in example computing system 202 or may include additional components not shown in FIG. 2.

As shown in FIG. 2, computing system 202 may include one or more processors 210 (“processor 210”), one or more communication units 212 (“communication unit 212”), and one or more storage devices 214 (“storage device 214”). As also shown in FIG. 2, storage device 214 may include a trending module 216, a data repository 218, an application marketplace module 220, and one or more machine learning models 222 (“machine learning models 222”). In general, a storage device may also be referred to herein as memory.

Processor 210 may implement functionality and/or execute instructions within computing system 202. For example, processor 210 may receive and execute instructions that provide the functionality of trending module 216, application marketplace module 220, and machine learning models 222. These instructions executed by processor 210 may cause computing system 202 to store and/or modify information within storage device 214 of processor 210 during program execution. Processor 210 may execute instructions of trending module 216, application marketplace module 220, and machine learning models 222 to perform one or more operations. That is trending module 216, application marketplace module 220, and machine learning models 222 may be operable by processor 210 to perform various functions described herein.

Communication unit 212 of computing system 202 may communicate with one or more external devices via one or more wired and/or wireless networks by transmitting and/or receiving network signals on the one or more networks. Examples of communication units 212 include a network interface card (e.g. such as an Ethernet card), an optical transceiver, a radio frequency transceiver, or any other type of device that may send and/or receive information. Other examples of communication unit 212 may include short wave radios, cellular data radios, wireless network radios, as well as universal serial bus (USB) controllers.

Storage device 214 within computing system 202 may store information for processing during operation of computing system 202 (e.g., computing system 202 may store data accessed by trending module 216, application marketplace module 220, and machine learning models 222 during execution at computing system 202). In some examples, storage device 214 may be a temporary memory, meaning that a primary purpose of storage device 214 is not long-term storage. Storage device 214 on computing system 202 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage device 214 may include one or more computer-readable storage media. Storage device 214 may be configured to store larger amounts of information than volatile memory. Storage device 214 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage device 214 may store program instructions and/or information (e.g., within data repository 218) associated with trending module 216, application marketplace module 220, and machine learning models 222.

Communication channels 224 (“COMM channel 248”) may interconnect each of the components 210, 212, and 214 for inter-component communications (physically, communicatively, and/or operatively). In some examples, communication channels 248 may include a system bus, a network connection, an inter-process communication data structure, or any other method for communicating data.

Trending module 216 may determine a trending metric for an application available through an application marketplace that is hosted by application marketplace module 220. For example, trending module 216 may determine whether the trending metric for a final period of a plurality of time periods is greater than the trending metric for an initial period of the plurality of time periods by an amount satisfying a first significance level. Trending module 216 may classify the application as trending in response to determining that the trending metric for the final period is greater than the trending metric for the initial period by the amount satisfying the first significance level. In some examples, trending module 216 may determine whether the trending metric for the final period is greater than the trending metric for an intermediate period of the plurality of time periods by an amount satisfying a second significance level.

Trending module 216 may classify the application as trending in response to: determining that the trending metric for the final period is greater than the trending metric for the initial period by the amount satisfying the first significance level; and determining that the trending metric for the final period is greater than the trending metric for the intermediate period by the amount satisfying the second significance level. In examples where the trending metric includes a plurality of metrics, trending module 216 may classify the application as trending based on one or more of the plurality of metrics having both an increasing short-term trend and long-term trend.

For example, if the trending metric includes an engagement metric and an active user metric, trending module 216 may classify the application as trending in response to: determining that the engagement metric for the final period is greater than the engagement metric for the initial period by the amount satisfying the first significance level; and determining that the engagement metric for the final period is greater than the engagement metric for the intermediate period by the amount satisfying the second significance level. Additionally, trending module 216 may classify the application as trending in response to: determining that the active user metric for the final period is greater than the active user metric for the initial period by the amount satisfying the first significance level; and determining that the active user metric for the final period is greater than the active user metric for the intermediate period by the amount satisfying the second significance level.

Assuming that the engagement metric follows a Gamma distribution, trending module 216 may determine whether a trend in the engagement metric is statistically significant using Equation 1:

$$P ( {T}_{i} ; k , θ ) \sim Gamma ( k , θ ) \qquad ( Equation 1 )$$

$${T}_{i} = CI ( {α}_{W} , k , θ ) + k θ , where k = {\sum }_{j}^{i - W , i - 1} {N}_{j} / W ,$$

$$θ = ( {\sum }_{j}^{i - W , i - 1} {T}_{i} ) / ( {\sum }_{j}^{i - W , i - 1} {N}_{j} )$$

$${T}_{i} \geq CI ( {α}_{W} , k , θ ) + k θ$$

where N is the number of active users during a time period, Tis a measure of app engagement, and W is the time window including the plurality of time periods. Trending module 216 may use a significance level (e.g., a) of 0.05 for long-term detection and a significance level of 0.1 for short-term detection.

Assuming that the active user metric follows a Poisson distribution, trending module 216 may determine whether a trend in the engagement metric is statistically significant using Equation 2:

$$P ( {N}_{i} ; λ ) \sim Poisson ( λ ) \qquad ( Equation 2 )$$

$${N}_{i} = CI ( {α}_{W} , λ ) + λ , where λ = {\sum }_{j}^{i - W , i - 1} {N}_{i} / W$$

$${N}_{i} \geq CI ( {α}_{W} , λ ) + λ$$

where N is the number of active users during a time period, and W is the time window including the plurality of time periods. Trending module 216 may use a significance level of 0.05 for long-term detection and a significance level of 0.1 for short-term detection.

In any case, responsive to trending module 216 classifying the application as trending, application marketplace module 220 may display the application as trending in the application marketplace (e.g., under the “Trending Application” category). In this way, application marketplace module 220 may promote the visibility and adoption of the application among users 108 who are interested in trending applications.

In some examples, computing system 202 may apply machine learning models 222 to predict (e.g., infer, forecast, project, etc.) before onset of the final period of the plurality of time periods whether trending module 216 will classify an application as trending. Machine learning models 222 may represent one or more of various different types of machine-learned models. In some examples, machine learning models 222 may perform binary classification, regression, clustering, anomaly detection, and/or other tasks.

Machine learning models 222 may perform classification in which machine learning models 222 provides a numerical value descriptive of a degree to which it is believed that the application should be classified into a “trending” class or a “not trending” class. In some examples, the numerical values provided by machine learning models 222 may be referred to as “confidence scores” that are indicative of a respective confidence associated with classification of the input into the respective class. In some examples, the confidence scores may be compared to one or more thresholds to render a discrete categorical prediction. In some examples, only a certain number of classes (e.g., one) with the relatively largest confidence scores may be selected to render a discrete categorical prediction.

Machine learning models 222 may use input data stored in data repository 218 to provide output data, such as a prediction about whether trending module 216 will classify an application as trending. The input data in data repository 218 may include application usage, installation history, etc. The computing devices (e.g., computing devices 104) may provide computing system 202 with at least some of the information used by machine learning models 222.

Machine learning models 222 may perform regression to provide output data in the form of a continuous numeric value. The continuous numeric value may correspond to any number of different metrics or numeric representations, including, for example, scores or other numeric representations. As examples, machine learning models 222 may perform linear regression, polynomial regression, or nonlinear regression. As examples, machine learning models 222 may perform simple regression or multiple regression. As described above, in some examples, a Softmax function or other function or layer may be used to squash a set of real values respectively associated with two or more possible classes to a set of real values in the range (0, 1) that sum to one.

Machine learning models 222 may perform various types of clustering. For example, machine learning models 222 may identify one or more previously-defined clusters to which the input data most likely corresponds. Machine learning models 222 may identify one or more clusters within the input data. That is, in instances in which the input data includes multiple objects, documents, or other entities, machine learning models 222 may sort the multiple entities included in the input data into a number of clusters. In some examples in which machine learning models 222 performs clustering, machine learning models 222 may be trained using unsupervised learning techniques.

Machine learning models 222 may perform anomaly detection or outlier detection. For example, machine learning models 222 may identify input data that does not conform to an expected pattern or other characteristic (e.g., as previously observed from previous input data). As examples, the anomaly detection may be used for detecting anomalous application usage data.

Responsive to machine learning models 222 predicting that trending module 216 will classify the application as trending, application marketplace module 220 may display the application as trending in the application marketplace. In this way, application marketplace module 220 may preemptively promote the visibility and adoption of the application among users 108 (e.g., before the application achieves mainstream popularity).

In some examples, computing system 202 may train machine learning models 222 based on an accuracy of predictions by machine learning models 222. For example, computing system 202 may attempt to optimize an objective function, such as a Precision Recall-Area Under the Curve (PR-AUC). As a result, machine learning models 222 may correctly predict whether trending module 216 will classify an application as trending more often.

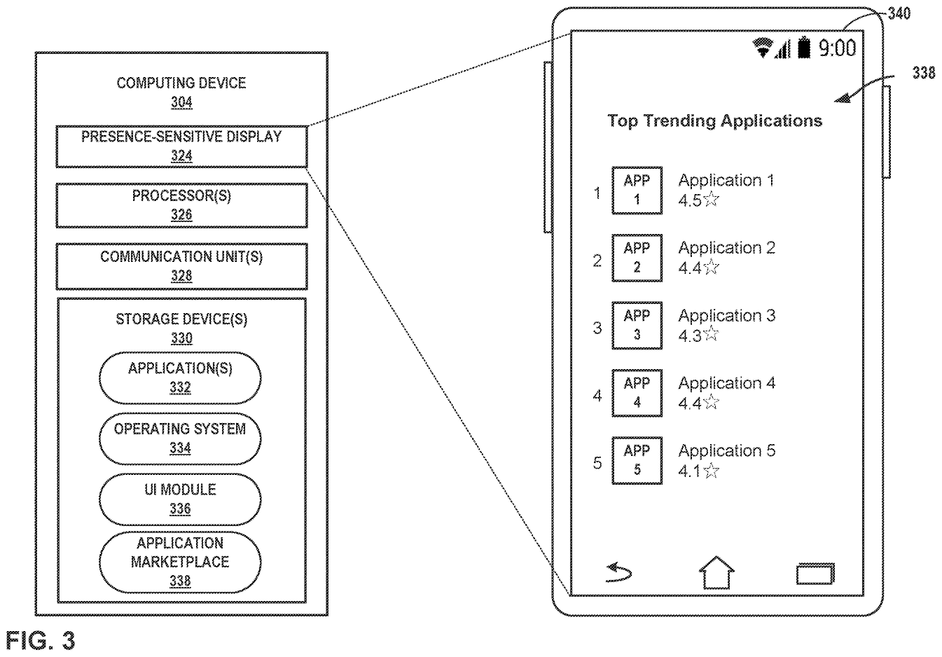

FIG. 3 is a block diagram illustrating details of a computing device 304 in accordance with one or more techniques of this disclosure. Computing device 304 of FIG. 3 may be an example of computing device 104 illustrated in FIG. 1. FIG. 3 illustrates only one particular example of computing device 304, and many other examples of computing device 304 may be used in other instances and may include a subset of the components included in example computing device 304 or may include additional components not shown in FIG. 3.

As shown in FIG. 3, computing device 304 may include one or more presence-sensitive displays 324 (“presence-sensitive display 324”), one or more processors 326 (“processor 326”), one or more communication units 328 (“communication unit 328”), one or more output components 246 (output component 246″), and one or more storage devices 330 (“storage device 330”). As also shown in FIG. 3, storage device 330 may include one or more applications 332 (“application 332”), an operating system 334 (“OS 334”), a user interface module 336 (“UI module 336”), and an application marketplace 338.

Presence-sensitive display 324 may identify input (e.g., touch and non-touch input) from a user of respective computing device 304. For instance, presence-sensitive display 324 may identify indications of input by identifying one or more gestures from a user (e.g., the user touching, pointing, and/or swiping at or near one or more locations of presence-sensitive display 324 with a finger, stylus pen, or another user input element). Presence-sensitive display 324 may output information to a user in the form of a user interface (UI), which may be associated with functionality provided by computing device 304. Such UIs may be associated with computing platforms, operating systems, applications, and/or services executing at or accessible from computing device 304 (e.g., electronic message applications, chat applications, Internet browser applications, mobile or desktop operating systems, social media applications, electronic games, menus, and other types of applications).

Processor 326 may implement functionality and/or execute instructions within computing device 304. For example, processor 326 may receive and execute instructions that provide the functionality of application 332, OS 334, and UI module 336. These instructions executed by processor 326 may cause computing device 304 to store and/or modify information within storage device 330 of processor 326 during program execution. Processor 326 may execute instructions of application 332, OS 334, and UI module 336 to perform one or more operations. That is, application 332, OS 334, and UI module 336 may be operable by processor 326 to perform various functions described herein.

Communication unit 328 of computing device 304 may communicate with one or more external devices via one or more wired and/or wireless networks by transmitting and/or receiving network signals on the one or more networks. Examples of communication units 244 include a network interface card (e.g. such as an Ethernet card), an optical transceiver, a radio frequency transceiver, a GPS receiver, or any other type of device that can send and/or receive information. Other examples of communication unit 328 may include short wave radios, cellular data radios, wireless network radios, as well as universal serial bus (USB) controllers.

Storage device 330 within computing device 304 may store information for processing during operation of computing device 304 (e.g., computing device 304 may store data accessed by application 332, OS 334, and UI module 336 during execution at computing device 304). In some examples, storage device 330 may be a temporary memory, meaning that a primary purpose of storage device 330 is not long-term storage. Storage device 330 on computing device 304 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage device 330 may include one or more computer-readable storage media. Storage device 330 may be configured to store larger amounts of information than volatile memory. Storage device 330 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage device 330 may store program instructions and/or information associated with application 332, OS 334, and UI module 336.

Computing device 304 may download, install, and execute application 332 (e.g., using one or more of communication units 328). Application 332 may represent a first party application developed and provided as an application integrated into OS 334 or a third-party application that a user of computing device 304 obtains via application marketplace 338 provided by way of operating system 334. Application 332 may extend software functionality of computing device 304, where application 332 may execute within an execution environment presented by OS 334. Application 332 may, as a few examples, provide gaming services (e.g., video games), email services, web browsing services, texting and/or chat services, web conferencing services, video conferencing services, music services (including streaming music services), video services (including video streaming services), navigation services, word processing services, spreadsheet services, slide and/or presentation services, assistant services, text entry services, or any other service commonly provided by applications.

OS 334, or a component thereof, may manage interactions between applications and a user of computing device 304. In some examples, UI module 336 may be considered a component of OS 334. UI module 336 may manage user interactions with presence-sensitive display 324 and other components of computing device 304. For example, UI module 336 may output a GUI 340 and may cause presence-sensitive display 324 to display GUI 340 as a user of computing device 304 views output and/or provides input at presence-sensitive display 324 or other components of computing device 304. In the example of FIG. 3, GUI 340 may include an indication of the top trending applications in application marketplace 338, as classified in accordance with techniques of this disclosure. While the example of FIG. 3 illustrates only five applications, it should be understood that the techniques of this disclosure may be applied to identify and display any number of trending applications in the application marketplace, such as 100, 1000, etc.

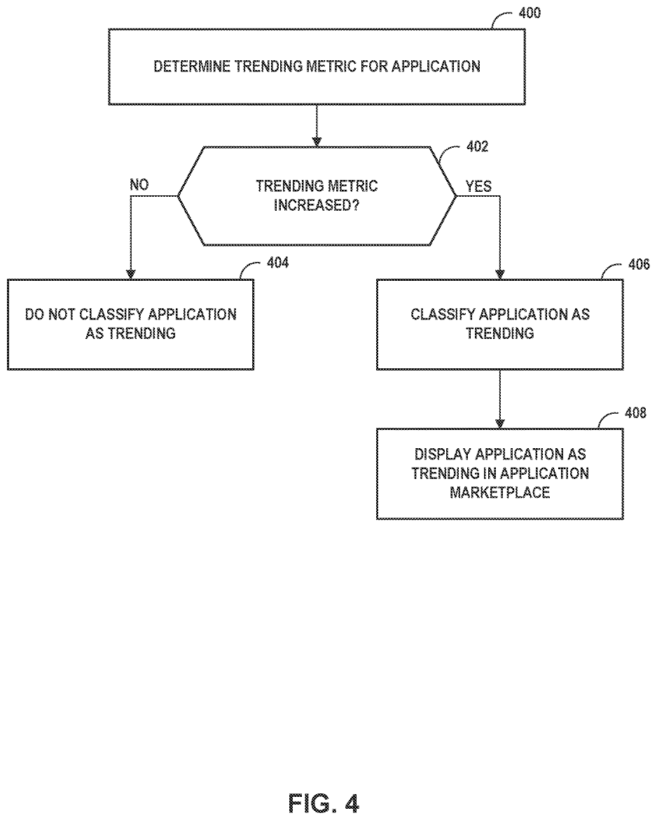

FIG. 4 is a flowchart illustrating example operations of an example computing system in accordance with one or more aspects of the present disclosure. Although the example operation of FIG. 4 is described as being performed by computing system 202 of FIG. 2, in other examples some or all of the example operation may be performed by another computing device.

Trending module 216 may determine a trending metric for an application (e.g., application 332) available through an application marketplace (e.g., application marketplace 338) that is hosted by application marketplace module 220 (400). For example, trending module 216 may determine a trending metric for each period of a plurality of time periods.

Trending module 216 may determine whether the trending metric for the application has increased in at least the long-term (402). For example, trending module 216 may determine whether the trending metric for a final period of the plurality of time periods is greater than the trending metric for an initial period of the plurality of time periods by an amount satisfying a first significance level. Responsive to determining that the trending metric for the final period is not greater than the trending metric for the initial period by the amount satisfying the first significance level (“NO” branch of 402), trending module 216 may not classify the application as trending (404). Responsive to determining that the trending metric for the final period is greater than the trending metric for the initial period by the amount satisfying the first significance level (“YES” branch of 402), trending module 216 may classify the application as trending (406).

In some examples, trending module 216 may determine whether the trending metric for the application has increased in the short-term and the long-term. For example, trending module 216 may determine whether the trending metric for the final period is greater than the trending metric for an intermediate period of the plurality of time periods by an amount satisfying a second significance level. In this example, responsive to determining that the trending metric has not increased by a statistically significant amount in both the short-term and the long-term (“NO” branch of 402), trending module 216 may not classify the application as trending (404). Responsive to determining that the trending metric has increased by a statistically significant amount in both the short-term and the long-term (“YES” branch of 402), trending module 216 may classify the application as trending (406).

Responsive to trending module 216 classifying the application as trending, application marketplace module 220 may display the application as trending in the application marketplace (408). In this way, application marketplace module 220 may promote the visibility and adoption of the application among users 108 who are interested in trending applications.

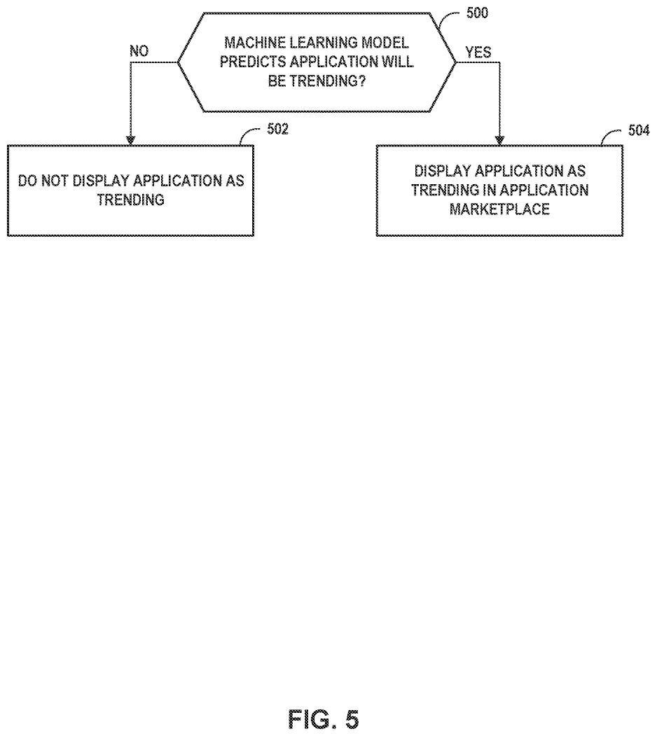

FIG. 5 is a flowchart illustrating example operations of an example computing system in accordance with one or more aspects of the present disclosure. Although the example operation of FIG. 5 is described as being performed by computing system 202 of FIG. 2, in other examples some or all of the example operation may be performed by another computing device.

Computing system 202 may apply machine learning models 222 to predict before onset of the final period of the plurality of time periods whether trending module 216 will classify an application as trending (500). For example, machine learning models 222 may perform classification in which machine learning models 222 provides a numerical value descriptive of a degree to which it is believed that the application should be classified into a “trending” class or a “not trending” class.

Responsive to machine learning models 222 predicting that trending module 216 will not classify the application as trending (“NO” branch of 500), application marketplace module 220 may not display the application as trending in the application marketplace unless and until trending module 216 actually classifies the application as trending (502). Responsive to machine learning models 222 predicting that trending module 216 will classify the application as trending (“YES” branch of 500), application marketplace module 220 may display the application as trending in the application marketplace (504). In this way, application marketplace module 220 may preemptively promote the visibility and adoption of the application among users 108 (e.g., before the application achieves mainstream popularity). In some examples, computing system 202 may train machine learning models 222 based on an accuracy of predictions by machine learning models 222. As a result, machine learning models 222 may correctly predict whether trending module 216 will classify an application as trending more often.

The following examples are illustrative of the techniques described herein.

Example 1: A method includes determining, by a computing system and for each time period from a plurality of time periods, a trending metric for an application available through an application marketplace; determining, by the computing system, whether the trending metric for a final period of the plurality of time periods is greater than the trending metric for an initial period of the plurality of time periods by an amount satisfying a first significance level; classifying, by the computing system, the application as trending in response to determining that the trending metric for the final period is greater than the trending metric for the initial period by the amount satisfying the first significance level; and displaying, by the computing system, the application as trending in the application marketplace in response to classifying the application as trending.

Example 2: The method of example 1, further includes determining, by the computing system, whether the trending metric for the final period of the plurality of time periods is greater than the trending metric for an intermediate period of the plurality of time periods by an amount satisfying a second significance level, wherein the first significance level is less than the second significance level, and wherein classifying the application as trending further comprises classifying the application as trending in response to determining that the trending metric for the final period is greater than the trending metric for the intermediate period by the amount satisfying the second significance level.

Example 3: The method of example 1 or 2, wherein the trending metric comprises one or more of an engagement metric or an active user metric, and wherein the engagement metric measures an amount of time a user spends interacting with the application, and wherein the active user metric measures a number of users who have the application installed on a computing device and have used the computing device during the plurality of time periods.

Example 4: The method of example 3, wherein the engagement metric follows a Gamma distribution, and wherein the active user metric follows a Poisson distribution.

Example 5: The method of any of examples 1-4, further comprising applying, by the computing system, a machine learning model to predict before onset of the final period whether the application will be classified as trending.

Example 6: The method of example 5, further comprising displaying, by the computing system, the application as trending in the application marketplace in response to the machine learning model predicting that the application will be classified as trending.

Example 7: The method of example 5 or 6, further comprising training, by the computing system, the machine learning model based on an accuracy of predictions by the machine learning model.

Example 8: The method of any of examples 1-7, wherein the time period is a day.

Example 9: The method of any of examples 1-8, wherein the plurality of time periods consists of 21 time periods.

Example 10: The method of any of examples 1-9, wherein the plurality of time periods is a sliding time window.

Example 11: A computing system includes one or more processors; and a memory that stores instructions that, when executed by the one or more processors, cause the one or more processors to: determine, for each time period from a plurality of time periods, a trending metric for an application available through an application marketplace; determine whether the trending metric for a final period of the plurality of time periods is greater than the trending metric for an initial period of the plurality of time periods by an amount satisfying a first significance level; classify the application as trending in response to determining that the trending metric for the final period is greater than the trending metric for the initial period by the amount satisfying the first significance level; and display the application as trending in the application marketplace in response to classifying the application as trending.

Example 12: The computing system of example 11, wherein the instructions further cause the one or more processors to: determine whether the trending metric for the final period of the plurality of time periods is greater than the trending metric for an intermediate period of the plurality of time periods by an amount satisfying a second significance level, wherein the first significance level is less than the second significance level, and wherein the one or more processors classify the application as trending by classifying the application as trending further in response to determining that the trending metric for the final period is greater than the trending metric for the intermediate period by the amount satisfying the second significance level.

Example 13: The computing system of example 11 or 12, wherein the trending metric comprises one or more of an engagement metric or an active user metric, and wherein the engagement metric measures an amount of time a user spends interacting with the application, and wherein the active user metric measures a number of users who have the application installed on a computing device and have used the computing device during the plurality of time periods.

Example 14: The computing system of example 13, wherein the engagement metric follows a Gamma distribution, and wherein the active user metric follows a Poisson distribution.

Example 15: The computing system of any of examples 11-14, wherein the instructions further cause the one or more processors to apply a machine learning model to predict before onset of the final period whether the application will be classified as trending.

Example 16: The computing system of example 15, wherein the instructions further cause the one or more processors to display the application as trending in the application marketplace in response to the machine learning model predicting that the application will be classified as trending.

Example 17: The computing system of example 15 or 16, wherein the instructions further cause the one or more processors to train the machine learning model based on an accuracy of predictions by the machine learning model.

Example 18: The computing system of any of examples 11-17, wherein the time period is a day.

Example 19: The computing system of any of examples 11-18, wherein the plurality of time periods consists of 21 time periods.

Example 20: The computing system of any of examples 11-19, wherein the plurality of time periods is a sliding time window.

Example 21: A non-transitory computer-readable storage medium encoded with instructions that, when executed by one or more processors of a computing system, cause the one or more processors to: determine, for each time period from a plurality of time periods, a trending metric for an application available through an application marketplace; determine whether the trending metric for a final period of the plurality of time periods is greater than the trending metric for an initial period of the plurality of time periods by an amount satisfying a first significance level; classify the application as trending in response to determining that the trending metric for the final period is greater than the trending metric for the initial period by the amount satisfying the first significance level; and display the application as trending in the application marketplace in response to classifying the application as trending.

Example 22: The non-transitory computer-readable storage medium of example 21, wherein the instructions further cause the one or more processors to: determine whether the trending metric for the final period of the plurality of time periods is greater than the trending metric for an intermediate period of the plurality of time periods by an amount satisfying a second significance level, wherein the first significance level is less than the second significance level, and wherein the one or more processors classify the application as trending by classifying the application as trending further in response to determining that the trending metric for the final period is greater than the trending metric for the intermediate period by the amount satisfying the second significance level.

Example 23: The non-transitory computer-readable storage medium of example 21 or 22, wherein the trending metric comprises one or more of an engagement metric or an active user metric, and wherein the engagement metric measures an amount of time a user spends interacting with the application, and wherein the active user metric measures a number of users who have the application installed on a computing device and have used the computing device during the plurality of time periods.

Example 24: The non-transitory computer-readable storage medium of example 23, wherein the engagement metric follows a Gamma distribution, and wherein the active user metric follows a Poisson distribution.

Example 25: The non-transitory computer-readable storage medium of any of examples 21-24, wherein the instructions further cause the one or more processors to apply a machine learning model to predict before onset of the final period whether the application will be classified as trending.

Example 26: The non-transitory computer-readable storage medium of example 25, wherein the instructions further cause the one or more processors to display the application as trending in the application marketplace in response to the machine learning model predicting that the application will be classified as trending.

Example 27: The non-transitory computer-readable storage medium of example 25 or 26, wherein the instructions further cause the one or more processors to train the machine learning model based on an accuracy of predictions by the machine learning model.

Example 28: The non-transitory computer-readable storage medium of any of examples 21-27, wherein the time period is a day.

Example 29: The non-transitory computer-readable storage medium of any of examples 21-28, wherein the plurality of time periods consists of 21 time periods.

Example 30: The non-transitory computer-readable storage medium of any of examples 21-29, wherein the plurality of time periods is a sliding time window.

Example 31: A computing device includes one or more processors; and a memory that stores instructions that, when executed by the one or more processors, cause the one or more processors to: determine, for each time period from a plurality of time periods, a trending metric for an application available through an application marketplace; determine whether the trending metric for a final period of the plurality of time periods is greater than the trending metric for an initial period of the plurality of time periods by an amount satisfying a first significance level; classify the application as trending in response to determining that the trending metric for the final period is greater than the trending metric for the initial period by the amount satisfying the first significance level; and display the application as trending in the application marketplace in response to classifying the application as trending.

Example 32: The computing device of example 31, wherein the instructions further cause the one or more processors to: determine whether the trending metric for the final period of the plurality of time periods is greater than the trending metric for an intermediate period of the plurality of time periods by an amount satisfying a second significance level, wherein the first significance level is less than the second significance level, and wherein the one or more processors classify the application as trending by classifying the application as trending further in response to determining that the trending metric for the final period is greater than the trending metric for the intermediate period by the amount satisfying the second significance level.

Example 33: The computing device of example 31 or 32, wherein the trending metric comprises one or more of an engagement metric or an active user metric, and wherein the engagement metric measures an amount of time a user spends interacting with the application, and wherein the active user metric measures a number of users who have the application installed on a computing device and have used the computing device during the plurality of time periods.

Example 34: The computing device of example 33, wherein the engagement metric follows a Gamma distribution, and wherein the active user metric follows a Poisson distribution.

Example 35: The computing device of any of examples 31-34, wherein the instructions further cause the one or more processors to apply a machine learning model to predict before onset of the final period whether the application will be classified as trending.

Example 36: The computing device of example 35, wherein the instructions further cause the one or more processors to display the application as trending in the application marketplace in response to the machine learning model predicting that the application will be classified as trending.

Example 37: The computing device of example 35 or 36, wherein the instructions further cause the one or more processors to train the machine learning model based on an accuracy of predictions by the machine learning model.

Example 38: The computing device of any of examples 31-37, wherein the time period is a day.

Example 39: The computing device of any of examples 31-38, wherein the plurality of time periods consists of 21 time periods.

Example 40: The computing device of any of examples 31-39, wherein the plurality of time periods is a sliding time window.

Example 41: A computer-readable storage medium encoded with instructions that, when executed by one or more processors of a computing system, cause the one or more processors to: determine, for each time period from a plurality of time periods, a trending metric for an application available through an application marketplace; determine whether the trending metric for a final period of the plurality of time periods is greater than the trending metric for an initial period of the plurality of time periods by an amount satisfying a first significance level; classify the application as trending in response to determining that the trending metric for the final period is greater than the trending metric for the initial period by the amount satisfying the first significance level; and display the application as trending in the application marketplace in response to classifying the application as trending.

Example 42: The computer-readable storage medium of example 41, wherein the instructions further cause the one or more processors to: determine whether the trending metric for the final period of the plurality of time periods is greater than the trending metric for an intermediate period of the plurality of time periods by an amount satisfying a second significance level, wherein the first significance level is less than the second significance level, and wherein the one or more processors classify the application as trending by classifying the application as trending further in response to determining that the trending metric for the final period is greater than the trending metric for the intermediate period by the amount satisfying the second significance level.

Example 43: The computer-readable storage medium of example 41 or 42, wherein the trending metric comprises one or more of an engagement metric or an active user metric, and wherein the engagement metric measures an amount of time a user spends interacting with the application, and wherein the active user metric measures a number of users who have the application installed on a computing device and have used the computing device during the plurality of time periods.

Example 44: The computer-readable storage medium of example 43, wherein the engagement metric follows a Gamma distribution, and wherein the active user metric follows a Poisson distribution.

Example 45: The computer-readable storage medium of any of examples 41-44, wherein the instructions further cause the one or more processors to apply a machine learning model to predict before onset of the final period whether the application will be classified as trending.

Example 46: The computer-readable storage medium of example 45, wherein the instructions further cause the one or more processors to display the application as trending in the application marketplace in response to the machine learning model predicting that the application will be classified as trending.

Example 47: The computer-readable storage medium of example 45 or 46, wherein the instructions further cause the one or more processors to train the machine learning model based on an accuracy of predictions by the machine learning model.

Example 48: The computer-readable storage medium of any of examples 41-47, wherein the time period is a day.

Example 49: The computer-readable storage medium of any of examples 41-48, wherein the plurality of time periods consists of 21 time periods.

Example 50: The computer-readable storage medium of any of examples 41-49, wherein the plurality of time periods is a sliding time window.

Example 51: A computing device includes means configured to perform any of the methods of claims 1-9.

Example 52: A computer-readable storage medium includes instructions that, when executed, cause one or more processors of a computing system to perform any one of the methods of claims 1-9.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

1-12. (canceled)

13. A method comprising:
determining, by a computing system and for each time period from a plurality of time periods, a trending metric for an application available through an application marketplace;
determining, by the computing system, whether the trending metric for a final period of the plurality of time periods is greater than the trending metric for an initial period of the plurality of time periods by an amount satisfying a first significance level;
classifying, by the computing system, the application as trending in response to determining that the trending metric for the final period is greater than the trending metric for the initial period by the amount satisfying the first significance level; and
displaying, by the computing system, the application as trending in the application marketplace in response to classifying the application as trending.

14. The method of claim 1, further comprising:
determining, by the computing system, whether the trending metric for the final period of the plurality of time periods is greater than the trending metric for an intermediate period of the plurality of time periods by an amount satisfying a second significance level,
wherein the first significance level is less than the second significance level, and wherein classifying the application as trending further comprises classifying the application as trending in response to determining that the trending metric for the final period is greater than the trending metric for the intermediate period by the amount satisfying the second significance level.

15. The method of claim 1, wherein the trending metric comprises one or more of an engagement metric or an active user metric, and wherein the engagement metric measures an amount of time a user spends interacting with the application, and wherein the active user metric measures a number of users who have the application installed on a computing device and have used the computing device during the plurality of time periods.

16. The method of claim 3, wherein the engagement metric follows a Gamma distribution, and wherein the active user metric follows a Poisson distribution.

17. The method of claim 1, further comprising applying, by the computing system, a machine learning model to predict before onset of the final period whether the application will be classified as trending.

18. The method of claim 5, further comprising displaying, by the computing system, the application as trending in the application marketplace in response to the machine learning model predicting that the application will be classified as trending.

19. The method of claim 5, further comprising training, by the computing system, the machine learning model based on an accuracy of predictions by the machine learning model.

20. The method of claim 1, wherein the time period is a day.

21. The method of claim 1, wherein the plurality of time periods consists of 21 time periods.

22. The method of claim 1, wherein the plurality of time periods is a sliding time window.

23. A computing system comprising:
a memory that stores instructions; and
one or more processors that execute the instructions to:
determine, for each time period from a plurality of time periods, a trending metric for an application available through an application marketplace;
determine whether the trending metric for a final period of the plurality of time periods is greater than the trending metric for an initial period of the plurality of time periods by an amount satisfying a first significance level;
classify the application as trending in response to determining that the trending metric for the final period is greater than the trending metric for the initial period by the amount satisfying the first significance level; and
display the application as trending in the application marketplace in response to classifying the application as trending.

24. The computing system of claim 23, wherein the one or more processors further execute the instructions to:
determine whether the trending metric for the final period of the plurality of time periods is greater than the trending metric for an intermediate period of the plurality of time periods by an amount satisfying a second significance level,
wherein the first significance level is less than the second significance level, and wherein classifying the application as trending further comprises classifying the application as trending in response to determining that the trending metric for the final period is greater than the trending metric for the intermediate period by the amount satisfying the second significance level.

25. The computing system of claim 23, wherein the trending metric comprises one or more of an engagement metric or an active user metric, and wherein the engagement metric measures an amount of time a user spends interacting with the application, and wherein the active user metric measures a number of users who have the application installed on a computing device and have used the computing device during the plurality of time periods.

26. The computing system of claim 25, wherein the engagement metric follows a Gamma distribution, and wherein the active user metric follows a Poisson distribution.

27. The computing system of claim 23, wherein the one or more processors further execute the instructions to apply a machine learning model to predict before onset of the final period whether the application will be classified as trending.

28. The computing system of claim 27, wherein the one or more processors further execute the instructions to display the application as trending in the application marketplace in response to the machine learning model predicting that the application will be classified as trending.

29. The computing system of claim 27, wherein the one or more processors further execute the instructions to train the machine learning model based on an accuracy of predictions by the machine learning model.

30. The method of claim 1, wherein the plurality of time periods consists of 21 time periods.

31. The method of claim 1, wherein the plurality of time periods is a sliding time window.

32. A computer-readable storage medium encoded with instructions that, when executed by one or more processors of a computing system, cause the one or more processors to:
determine, for each time period from a plurality of time periods, a trending metric for an application available through an application marketplace;
determine whether the trending metric for a final period of the plurality of time periods is greater than the trending metric for an initial period of the plurality of time periods by an amount satisfying a first significance level;
classify the application as trending in response to determining that the trending metric for the final period is greater than the trending metric for the initial period by the amount satisfying the first significance level; and
display the application as trending in the application marketplace in response to classifying the application as trending.
